(19) United States
(12) Patent Application Publication
(10) Pub. No.: US 2003/0208697 A1
(43) Pub. Date: Nov. 6, 2003

(54) Sequential authentication with infinitely variable codes

(76) Inventor: Richard M. Gardner, Chelwood Gate (GB)

Correspondence Address: RICHARD M. GARDNER, INNESWOOD, BEACONSFIELD ROAD, CHELWOOD GATE, RH17 7LE, GB

(21) Appl. No.: 10/421,029

(22) Filed: Apr. 24, 2003

(30) Foreign Application Priority Data
Apr. 24, 2002 (GB) GB 0209385.4

(51) Int. Cl. H04L 9/32

(52) U.S. Cl. 713/202

(57) ABSTRACT

A method and apparatus for the authentication of a person or thing (being a computer, a data carrying card or a machine) registered in a system to the Controller of that system by means of authentication Codes which are characterised by being variable for each occasion of use, the authentication Codes being derived from the input of predetermined specified fixed and variable data, the variable data being derived primarily from a sequential function of the immediately preceding authentication Codes used, with in each case a treatment of the data input serving to mix the elements in a manner whose outcome is known only to the person or thing and the Controller of the system, allowing for the provision for visible reciprocal authentication of the system to the registered person or thing, for provision for Code calculation in advance allowing for integrated identification and authentication, and provision for other benefits flowing solely from a variable Code which is both unpredictable externally yet readily calculated by the registered person or machine.

### CROSS REFERENCE TO RELATED APPLICATIONS

This application claims a priority date of Apr. 24, 2002 from filed Patent in England GB 0209385.4

### FEDERALLY SPONSORED RESEARCH OR DEVELOPMENT

Not applicable

### REFERENCE TO A MICROFICHE APPENDIX

Not applicable

### BACKGROUND TO THE INVENTION

The present invention discloses a method and apparatus providing for the authentication to a Controller of a computer, Internet or Telephone linked System (a “System”) of a User of that System (a “User”), by means of an infinite series of variable authentication Codes, derived in part from the immediately preceding authentication.

Authentication, especially remote authentication carries with it the risk of oversight or interception of the authentication Codes which cannot easily be prevented and the risk is that such interception may facilitate unauthorised access to a system on a future occasion. Where an authentication Code is fixed, there is an obvious risk, countered in many high security systems by encryption.

The essence of the present invention is that without the need for encryption the functionally infinite variety of the authentication Codes and the particular method of their generation not only makes unauthorised use of intercepted authentication Codes difficult or impossible, but also enables various secondary features to be available which are unique to the invention, as set out below.

As the context may require, the word “System” means either a range of linked elements (for example a central computer and linked personal computers, or a central banking computer and its registered Users), or those particular elements being described (for example an authentication System), and “Master System” is used to denote that central and controlling part of a System which controls and grants or denies authentication

The simplest and oldest form of controlling access would be a key (in a key and lock “System”). In modern Systems, a token or a device (called a “device”) or a data-carrying card (a “card”), any of which is capable of producing a fixed code readable by a machine or computer to grant or deny access may be used as a key: however, although mere possession of such a device or card may allow access, such a System says nothing about who has that possession, and could not be called authentication.

As an improvement to such a System, a device or card might have a particular code that identifies who the user is (or at least whose device is being used) and may also be associated with a fixed Personal Identification Number (“PIN”) which has to be entered onto a machine (such as an Automated Teller Machine) or reader before the device or card communicated with a Master System.

However, Systems involving “devices” and fixed PIN's generate considerable “key management” problems, in that the secret attached to a device has to be recorded both as to being attributed to a particular device and to a particular user. Moreover, both a device and a card usually provide a fixed signal which may be intercepted over an open network: to overcome these problems, several Systems have emerged which produce a variable Code which authenticates the device to the Master System.

U.S. Pat. No. 4,720,860 and U.S. Pat. No. 5,367,572 Weiss reveal variable authentication Codes derived from a fixed PIN entry and a time or other variable algorithmic function. U.S. Pat. No. 5,056,141 Dyke discloses a means of matching variable word pairs contained both in a record (or device) kept by the user and in the Master System, such word-pairs having been pre-registered by the user. PCT Patent WO 91/09383Watkins is similarly based upon pre-registered cue-responses. U.S. Pat. No. 5,163,097 Pegg discloses a variable PIN based upon selected algorithms which are known both to the user device and to the Master System, based upon a Fixed access number being altered by a variable cipher algorithm resulting in a different access key being used on each occasion. U.S. Pat. No. 5,355,413 Hisashi Ohno discloses a series of different numbers derived from an algorithm shared by the device and the Master System. U.S. Pat. No. 5,606,614 Brady et al discloses a System and means of providing for a series of stored passwords which are used in sequence by the user from a device recording such passwords, and lastly U.S. Pat. No. 5,627,355 Rahman et al discloses a unique series of personal numbers maintained sequentially in a Master System and a device

Whilst these Systems clearly go some way towards solving the problem of authentication Codes being used over insecure networks and of preventing subsequent unauthorised use, none of them specifically authenticate the user, merely the device, even if the device is itself protected by a fixed PIN.

At a similar level, an Account number or User Identification number might be associated with a fixed PIN, without the necessity of any device, and this applies to many banking and network Systems. It also applies to existing payment card Systems, where the Payment Card Number is effectively the Account number (fairly readily known or intercepted) and other information (Expires date, name on card, Cardholder Verification Value etc.) is only available from the card itself and is similar to, though less secret than, a fixed PIN.

The problems of fixed PIN's in the field of payment card Systems and generally have been clear for some years and various Systems have been devised to avoid their use and improve security. Thus, U.S. Pat. No. 5239583 Parrillo discloses a variable PIN where one at least of the digits of the authentication Code vary for each of four occasions of use before repetition, based upon a four letter remembered fixed “password”. The relevant data from which the PIN's are selected are not remembered and are held on a sheet or card. There is also provision for an increased number of variables given additional Fixed passwords (four remembered four-letter passwords (equalling 16 letters in all) would give up to 10,000 variations). However the variations between sequential PIN's disclosed are not great (one digit only) and the System is not random. U.S. Pat. No. 5,251,259 Mosley discloses a System of 7 varying access keys derived from a Code Grid sent to the user and corresponding with a grid in the Master System. The useable elements of the grid are based upon a fixed PIN which identifies which numbers are to be used for each day of the week. This System suffers from the same defects as Parrillo.

A further improvement in the field of variable authentication Codes was disclosed in U.S. Pat. No. 002,013,904 Gardner, which reveals a method of producing a PIN which varies on each and every occasion of use in a controlled but unpredictable manner by the use of a series of Codes held on a random grid array and which form part of the actual authentication Codes in various, mainly date-related different permutations.

As a converse to the problems of the authentication by a Master System of a purported User, a User would like to be assured that the System to which he or she is connected is in fact what it claims to be i.e. it is their Master System and not a fake System or Website. In many fields, for example Internet banking, this is of course of critical importance.

The level of importance attached to reciprocal authentication will depend upon the consequences of unauthorised use, and this in turn will define the level of security required and consequential levels of complexity. In fact, in view of its simplicity, the present invention is equally applicable to cases where the desire for reciprocal authentication may be no more than that, or where, as in the field of for example remote banking or payment card transactions, it is of the utmost importance.

Various forms of encryption and Public Key Cryptography provide for a digital “handshake” as confirmation of authenticity: but the matter cannot be checked by the User and has to be taken on trust. Further, the other main contestant to variable authentication Codes in the authentication field, biometric systems, may become a standard for one way authentication (eventually, when they become more widely accepted), but they are clearly incapable of providing for reciprocal authentication.

The Office of the Comptroller of the Currency in the USA reported in July 2000 that fake Internet bank sites had been discovered which were used to obtain passwords and PIN's from Users and which could have (and almost certainly did) lead to bank losses or losses by Users. The banks are understandably somewhat reserved on publishing details, but the threat is an obvious one.

One method for the User to authenticate a Master System is for the User to be told by a third party that the Master System really is authentic, but this raises the further problem—is the third party really who it claims to be? There are provisions for third party certifiers to themselves be certified-but there is no end in sight. Eventually, someone has to take a risk (however minimal) that the certificates are in order and accept the communication as valid, or to accept a transaction, or grant access as the case may be. Average customers are not qualified to take this decision, and are unlikely to become so: what is needed is a System that all customers can understand.

Another related matter is Public Key Exchange and encryption, which is normally a part of third party certification. Again, however, the average customer is not equipped to deal with this and is unlikely to choose to do so. Even if he or she were inclined to participate, or if the whole problem of Key Exchange, Key Maintenance and encryption were entrusted to a computer with the customer taking no active role and having no need to understand what is going on at all, the end result is that one computer informs another computer that all is well. The customer has no way of knowing whether this is correct or incorrect, or recklessly made without caring one way or the other by some fraudulent third party or interloper. It is inherently a mysterious and not an open process, and not one that can be readily understood in actual practice: it is something the computer does and one either accepts it or is suspicious of it.

It is possible that other authentication systems would be capable of providing for reciprocal and not just one-way authentication at present, but it does not appear to have been suggested and does not therefore form part of the prior art. Clearly many systems inform the User that he or she is indeed connected to the System that they intended, but to paraphrase a famous quotation, “they would say that wouldn't they!”. Certainly those persons who have been connected to fake Bank sites and other sites, and tricked into revealing personal details, thought that they were properly connected and were told as much.

In the same manner that a variable authentication Code is clearly preferable to a fixed one, and indeed essential for reciprocal authentication, it is also the case that a Reciprocal authentication Code-from the System to the User confirming that the website for example is not a Fake-should also be variable, otherwise it is little better than the User being told to believe it. The User should be able to see for him or her self, by clear on-screen message, that it is so, and if a System can produce a variable authentication Code that is understood by a System, then clearly the System must be able to provide a Reciprocal Code (by the same general rules that provided the User variable Code in the first place) to the User which only the User would know was authentic.

Apart from many publications in the field of encryption and Public Key exchange, which are not regarded as relevant to the present invention, there is little other prior art in the field of authentication of a Master System to the User.

The essence of U.S. Pat. No. 002,013,964 (by the present inventor and concerning a variable PIN, its construction and use in authenticating a User to a Master System) is that the codes are infinitely variable yet because of the manner of construction were entirely separate and could not be predicted—i.e. they were non-sequential without this being stated as such. The present invention, whilst aiming for similar objectives as those disclosed in U.S. Pat. No. 002,013,904 Gardner relates to an entirely new method of producing a variable authentication Code to provide for the authentication of a User to a Master System. and similarly for the authentication of that Master System to the User by way of Reciprocal authentication and additionally to provide for further increases in security and related improvements to remote authentication as are made possible by incorporating into each authentication the variable sequential elements of the immediately preceding authentication, the current authentication Code then forming an important element of the next following authentication, in a manner which is not obvious even to those skilled in the art.

### BRIEF SUMMARY OF THE INVENTION

Given the objective of an authentication Code that varies on each and every occasion of use, and which it is plain has attributes which a fixed authentication Code cannot possess, the prior art (including U.S. Pat. No. 002,013,904 by the present inventor) covers systems that proceed each time from first principles via fixed data, variable data and algorithms to the variable Code, with the actual method chosen being capable of replication for future authentication. Having produced the first variable authentication Code, the second would be similarly produced and so on. Thus, the concept of an infinitely variable authentication Code seems to require a process that computes such a Code from a variety of input on each occasion, which is inherently not easy and had not been done before being revealed in GB234175.

The above approach to the problem now appears to the inventor to be conditioned by contemplating how to compute the first Code and by assuming that each following Code will require the same method and effort. If however one “starts” with the second Code, it is clear that a major and variable part of the input required for that second Code could be the first Code itself, with the third Code being based upon the second and so on. Each different Code will thus form a major part of the variable input for the next following Code, known to both sides (User and Master System) and therefore requiring no new sharing of information.

This concept may be combined with that of a Reciprocal Code—that the system producing a variable Code for access can clearly produce a variable Code to reply (the Reciprocal Code), both of which are verifiable by both sides (User and System): and clearly the Reciprocal Code itself, being the embodiment of the authentication by a User to a System and vice versa, is capable of providing at least a part of the next authentication Code to be supplied by a User-known to both sides and no-one else, variable within given known parameters, and based upon a confirmed authentication. Thus each authentication could be sequential to and derived in large part from the immediately preceding authentication.

Accordingly, the present invention describes a method and apparatus for the authentication of a person registered in a system to the Controller of that system by means of authentication Codes which are characterised by being variable for each occasion of use, the authentication Codes being derived from the input by the person of predetermined specified fixed and variable data, the fixed data including an identifying account number and the variable data being derived in part from randomly generated characters communicated for the purpose to that person by the Controller of the system for use on the first occasion of authentication and thereafter derived in part as a sequential function from the immediately preceding authentication Codes used by that person, with in each case treatment of the data input serving to mix the elements in a manner whose outcome is known only to the person and the Controller of the system.

It is in part an extension of work set out in U.S. Pat. No. 002,013,904 Gardner by the present inventor: however, the objective of that application, the production of an infinitely variable authentication Code, is in a way the starting point for the present invention—which is that the production of a variable authentication Code by means of a sequential function of the last preceding authentication enables certain advantages to be realised which were not hitherto considered or available under the prior art.

Naturally the present invention requires a starting point—the first authentication—but once it is considered just as a “Start”, then it can be seen to present no difficulty whatsoever and to be perfectly straightforward: virtually any means of producing that first Code might be employed, including an entirely random number. In fact an entirely random number is the preferred start as it obviously cannot be guessed: and once “started” all subsequent authentication Codes follow from this in a direct sequential fashion.

As a further extension of the concept of a variable authentication Code followed by a variable reciprocal code completing a mutual authentication, with the next following authentication being based in part upon the last, it follows that the next authentication Code either is or can be calculated in advance. This means that it may be possible to dispense with any fixed reference or identification number and instead rely upon a database of continually varying authentication Codes which in turn relate to the particular registered User-integrated identification and authentication. This would not be at all difficult unless the database were very large indeed, and merely represents a “Sort” function as a switch between a static User base and a variable authentication Code.

Moreover, the main problem of remote authentication-interception of data—may therefore be largely avoided, if the authentication Code is itself both identifier and authenticator since an interceptor would be unable to, or have considerable difficulty in, linking the various Codes.

Even if separate identification were maintained, part of the variable authentication Code could be posted at the outer barrier Firewall so that only those authentication attempts which had at-least the first part of the correct Code would be admitted “inside” with an obvious reduction in dangers of unauthorised access and denial of service attempts.

It should be stressed that the concept of a variable authentication Code is based upon the ability of both the Master System and the User to calculate the variable Code quite independently, by means (obviously) of having synchronised means of Code generation. Thus, a fixed authentication Code needs only to be recorded by both sides before use but a variable authentication Code requires the agreement beforehand of the method of producing that Code and the input required to achieve it, some of which must by hypothesis be itself variable. The sequential value derived from the reciprocal Code is such a variable input and combined with other fixed inputs, perhaps including a Fixed PIN, produces the variable Code.

The immunity from the effects of interception is based upon the fact that although subject to interception like any other System, the random and variable nature of the authentication Codes mean that no use may be made of any material intercepted. For this reason, encryption of the authentication Codes is not necessary, although insofar as it is automatic it will not affect the visible nature of the Reciprocal authentication of the Master System to the User.

The role of the Fixed PIN in a variable PIN system is commonly as a low security “key” to a higher security system, required to unlock a Token or device or computer programme which then provides a variable digital Code. Such a Fixed PIN could be registered with the Master System, which would then be in a position to both check that the correct Fixed PIN had been entered, and to assist a User who had forgotten his or her Fixed PIN and was therefore temporarily unable to access the System.

The work involved in allocating and keeping track of the various Fixed PIN's and which belonged to which registered User, and in dealing with forgotten PIN queries (here called collectively “Key Management”), is an expensive aspect of most systems. Moreover, it is an area with obvious security risks in relation to the relevant Administrators, and “insider” security breaches account for a high proportion of the total. Similar, and in some ways greater, Key Management problems arise in connection with encryption generally and PKI in particular.

The use of variable authentication Codes with sequential values provides an opportunity to reduce these costs or possibly to eliminate them entirely. Both are possible only because of the fact that each authentication Code is different from the last one, and is itself no clear guide to what the next one will be, by virtue of the quantum of unknown and unknowable other input (in addition to the one part which might be intercepted, the preceding variable authentication Code and Reciprocal Code).

In one embodiment of the invention, the Fixed PIN may be retrieved automatically, without requiring human intervention, by entering in lieu of the Fixed PIN some other required input data, normally entered by the system. Thus, a given fixed input may be split into two elements, one being a secondary checkable item such as date of Birth: normally the Fixed PIN and full value are required, but if the date of Birth is entered, a different Fixed value is entered by the programme which together makes up the correct input (i.e. as if the Fixed PIN had been entered): in practice, something other than the date of Birth (fairly readily available) would normally be used.

In a second variation, the User would set his or her own Fixed PIN which would be conveyed to the Master System (and then used by it thereafter to produce the correct Codes) during an on-line session i.e. immediately following authentication using the previous Fixed PIN. This would reduce Key Management issues and would mean that the Fixed PIN would only reside within the Firewall and would require no administrative action at all.

A third variation and important embodiment of the invention would be that the Fixed PIN is set by the User and although an essential ingredient of the User conveying the correct variable authentication Code to the Master System, the Fixed PIN is not a factor in computing the authentication Code itself and is never conveyed to the Master System at all. This is achieved by arranging for the next authentication Code to be computed (in the appropriate manner, known to both the User and the Master System) involving various inputs but not including any Fixed PIN: and then recording that Code as “reduced” by the Fixed PIN on the User programme, to be unlocked subsequently when the User “adds” the Fixed PIN. Thus a simple User algorithm would produce the authentication Code on the User inputting the Fixed PIN, wait patiently whilst another part of the User programme computed the next authentication Code (possibly being a complex derivative from the preceding Code), reduce the authentication Code result by the Fixed PIN Oust input by the User and held in temporary memory) and then store this reduced Code ready for the next time and forget the Fixed PIN.

The concept of “reducing” and “adding” are merely a means of describing a simple reversible arithmetic process applied to an authentication Code and a Fixed PIN, such that the authentication Code may be disguised by “reducing” it by the Fixed PIN and revealed again by “adding” the Fixed PIN, neither calculation figuring at all in what might otherwise be an extremely complex means of actually computing the authentication Code itself.

Moreover, although the Fixed PIN might be say 1 2 3 4, the factor used might be:

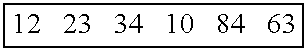

being 1^{st} 2, 2^{nd} 2, 3^{rd 2}, sum, multiplicand of 12*23*34,sum of all preceding and so on, all being MOD10 based figures.

Such a system would cut Key Management costs to a minimum: the Master System could not assist in retrieving a Fixed PIN as it would not know it, and the User's programme would not record it either. A forgotten PIN would have to be replaced (by the User) after logging on in an emergency fashion, involving re-entering part of the original start-up registration data.

Thus, the Fixed PIN would not be known by any party except for the User, and even Administrators could not get into the system except with their own access keys with full audit trail: the possibility for an Administrator to misuse a User's Fixed PIN would be entirely avoided.

A further advantage of a variable authentication Code forming a part of an unbroken sequence of authentication Codes, and seemingly available only to such a system, is that unauthorised access can only be attempted with the last sequential Code: this means that even if an interceptor was able to both record an Account Number with relevant authentication Code and also somehow knew how to compute the next authentication Code, (not really possible without insider data) he or she would still not be able to gain access unless that next authentication Code were “used” (i.e. it was a part of an authentication Code computation) immediately, or rather before the User “used” it him or her self. If that next authentication Code had in the meantime been used by the User, the interceptor would need to make a further intercept and again use that authentication Code as a sequential factor before the user.

The construction of the authentication Code means that for no or little more effort than that required for a conventional User Identification and a Fixed PIN, the present invention can provide for a functionally infinite variety of authentication Codes. The System does not rely upon encryption for protection but on the fact that the Codes are inherently unpredictable and incapable of “decoding” as there is no fixed “code”: the life of a variable authentication Code is only for a scintilla of time. Prior to the authentication attempt it does not “exist” although it is known what it will be: then it becomes fixed and transmitted in a moment and if correct is authenticated. This means that the next following authentication attempt will require a different authentication Code, is also now known, and the just-completed authentication Code is no longer of any relevance except for an audit log.

The variables are such that prediction is impossible without assistance from a System Administrator or a User. Accordingly, the System has the characteristic of counteracting any denial by a User that a particular access or authentication was in fact by that User, just as digital certificates are intended to do: thus, if User X was on-line or connected to the System on occasion A and again on occasion C, then it is hard to deny that it was also X on occasion B, since codes from A were used as the basis for Codes for occasion B, and Codes from B for occasion C.

Further, the System could be used by one person to authenticate another person remotely, provided both (or at least the one being authenticated) were registered with the Master System: thus if person X transmits a set of authentication Codes through person Y to the Master System (retaining a note of the correct Reciprocal Code), and subsequently receives from Y the correct Reciprocal Code, then person Y must have been authenticated by the Master System or Y would not have been given (to send on to X) X's reciprocal Code. The fact that Y now knows X's Reciprocal Code—part of the basis of X's next sequential access-attempt is of no significance: to make use of it, Y would also need substantially more Input details from X.

The essence of the present invention is that despite the authentication Codes being infinitely variable, they are known in advance by both the master System and by the User system., since this authentication Code may form an essential starting point for the next following authentication (as an infinitely variable input), which together with various fixed inputs (Fixed PIN and pre-registered numerical or other data) provides that next authentication Code in a manner that is inherently unpredictable without the necessary data.

### BRIEF DESCRIPTION OF THE DRAWINGS

FIG. 1 Conventional Authentication of a User with a Master System

FIG. 2 Sequential Authentication of a User/System with higher security requirements

FIG. 3A Integrated Sequential Identification/Authentication

FIG. 3B Smartcard use away from Home computer

FIG. 4A Sequential Authentication: Fixed PIN not known by Master System

FIG. 4B Data carrying card away from Home computer-secure system

FIG. 5 Illustrations of sequential function

### DETAILED DESCRIPTION OF THE INVENTION

The present invention is of a method and apparatus for the authentication of a person registered in a closed system to the Controller of that system by means of authentication Codes which are characterised by being variable for each occasion of use, the authentication Codes being derived from the input by the person of predetermined specified fixed and variable data, the fixed data including an identifying account number and the variable data being derived from randomly generated characters communicated for the purpose to that person by the Controller of the system for use on the first occasion of authentication and thereafter derived in part as a sequential function from the immediately preceding authentication Codes used by that person, with in each case an arithmetical or other treatment of the data input serving to mix the elements in a manner whose outcome is known only to the person and the Controller of the system.

Thus, the invention encompasses the proposition that this authentication is in part validated by the inclusion of elements in the authentication Codes derived directly from the preceding authentication Codes and which could not be known by any other person, and provides a means of enabling a Master System to require of an authorised User of that System and vice versa a series of characters (a variable authentication Code) which is infinitely variable for each and every occasion of use, with the memory required of the User being no more than for a conventional 4 digit PIN. The authentication Codes may be encrypted or passed in clear over an open network, since sufficient information is never conveyed to permit fraudulent authentication.

The word “infinite and infinitely ” in this context means that the number of Codes available is very many times more than could possibly be required in practice: for example, a User authenticating him or her self 10 times a day for 40 years would only use 10×365.25×40=146,100 whereas every 8 digit authentication Code (probably the minimum in practice for the invention) is one of 100,000,000, combinations

The invention involves the use of an Account Number for a registered User and certain registered information and data, possibly including a conventional Fixed PIN. This other registered data would vary in accordance with which aspect of the invention was to be used in a given system, but could include:—

[a Date of birth

[b another known date

[c credit card numbers and data (Expires date and CVV-Card Verification Value)

[d or other lengthy characters from documents habitually carried (driving licence, Library Card etc.)

The detailed construction of the authentication Code may be in any number of ways and this Patent application is intended to cover all such variations: the particular systems illustrated not being exhaustive and merely illustrative of particular embodiments of the invention, the principal and novel feature of which is that the basis of this authentication is the authentication Code used successfully for the immediately preceding authentication.

For example, specific details of the algorithm used to “mix” the various fixed and variable inputs into a authentication Code are not a part of the invention, which is intended to cover any and all means of mixing the data in a pre-arranged manner: those illustrated here are simple arithmetic functions with an element of computational sequentiality i.e. one digit may in part depend upon the preceding digit. Obviously the algorithm actually used could be extremely complex but the strength of the system is also based upon the number of inputs and the fact that over half of these are variables, not the details of the algorithm.

It is in fact not possible to “break” an authentication Code—once it has been used (and was therefore capable of being intercepted), access will either have been granted or refused, and in either event that particular authentication Code cannot be used again. What might be possible is to intercept two consecutive transactions for a particular User, to note down the transmitted data (the authentication Code & the Reciprocal Code) and to try and ascertain what input to the first authentication Code would produce the second authentication Code. As stated above, whether or not this were feasible would depend upon the amount of unknown input: at higher levels of input it would not at present and foreseen computer powers.

The authentication Code is a variable number, unlike a coded message, and does not sit still to be analysed. It is known only to the Master System although it should be produced as well by a User inputting the correct data: even knowing the algorithm used, a fraudster trying out different combinations of input could only test the correctness of any given authentication Code by submitting it to the Master System, which would not of course tolerate the millions of enquiries necessary for a trial and error attack.

It will also be clear that even the above attempt at computing the Input and thereby (from yet a further intercepted authentication and Reciprocal Code), using that Input to produce a genuine authentication Code, is only possible at all with “Away” use, since “Home” use will involve no fixed data interception and a trial and error approach could not work as above. There would be no other indication as it is a feature of the invention that the medium for inputting data (normally a PC) would not know what the next authentication Code was: whatever the input might be, Codes would be generated, right or wrong, and without any means of finding out without submitting the authentication Code for authentication.

In practice, the Codes can be of whatever length is desired without any impact upon the user at all: for example, if in “Home” use the only input required is a 4 digit fixed PIN, the User will neither know nor care if the resultant authentication Code were 4 or 44 digits long.

The construction of authentication Codes using various input formats are described below, all of them based upon a sequential element and all producing variable codes which are known by the Master System and computed by the User, and which are difficult (as in the first illustrations designed to make the principles clear) if not impossible (as in the invention proper) to predict. In each case:—

[a the fixed Input Data is assumed to be registered with the master System

[b the variable Input Data is based upon criteria agreed by the Master System and the User

[c the Sequential Code or Value is all or part of the immediately preceding authentication Code

each of these inputs being made available to the User in the one of the separate ways discussed

The actual arithmetical or other function used—the algorithm described—is not regarded as part of the present invention, since the benefits are obtained because of the principle of a variable authentication Code based upon a preceding authentication Code and the actual functions applied to the input data are only secondary.

1: Simple Sequential Function

As a means of illustrating the basic principle of the sequential function, a simple system could consist of:

[a a sequential function, being the immediately preceding authentication Code (or, on the first authentication, a random “Start” number

[b a fixed 4 digit PIN

The authentication Code would be the preceding Code plus the Fixed PIN, with the result restricted to 4 digits (i.e. if over 9999, a MOD 10,000 effect)

| | START | FIXED PIN | VAR. CODE |
|---|---|---|---|
| 1st authentication Code | 7874 | 1234 | 9108 |
| 2nd authentication Code | 9108 | 1234 | 342 |
| 3rd authentication Code | 342 | 1234 | 1576 |
| 4th authentication Code | 1576 | 1234 | 2810 |
| 5th authentication Code | 2810 | 1234 | 4044 |

Such a system would produce a constantly varying authentication Code which if it could not be overseen or intercepted would be impervious to attack. Moreover, a single or sporadic interception would not suffice to reveal the constituent numbers—two consecutive interceptions would be required to reveal the Fixed PIN. However, even knowing the fixed PIN would not enable a fraudulent access attempt to succeed unless it was used upon the immediately preceding authentication Code: in other words a third interception would be necessary to find out the then current authentication Code, to which would be added the computed intercepted Fixed PIN, with the result submitted in a format acceptable to the Master System and before the User had themselves “used” that preceding authentication Code.

Thus, if the 2^{nd} and ₃Td authentication attempts were intercepted, giving 0342 & 1576, the difference of 1234 could be seen to be the Fixed PIN, but would either have to be used immediately by adding it to 1576 (or at least before the User used the system again) or would require a further interception to find the sequential value. In other words, the Sequential Value 1576 would be “used” and cease to be of any value after the 4^{th} authentication.

If the authentication Code consisted only of the authentication Code i.e. without an account number and such that the Code was both an identification and an authentication, then targeted interception of a single User to generate differences and Fixed PIN's or sequential values would not be easy, if not impossible at longer authentication Code values.

2. Addition of Fixed Factors

As a further illustration of the principles of the invention, the simple system illustrated above could have:—

[a a 5 digit authentication Code (Sequential Value or Start Value)

[b a fixed 5 digit input based upon a registered number

[c a 4 digit Fixed PIN

Start Value 27845: Fixed Input 45293 Fixed PIN 1234

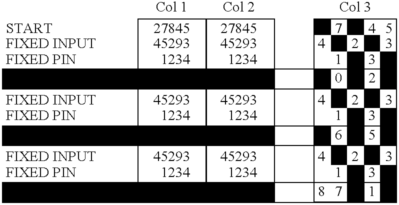

It will be noted that a longer authentication Code has been produced (which would make a guessing attempt more difficult) merely as a function of the sequential value, and without any increased input by the User at all. It will also be noted, however, that given two consecutive interceptions, the difference between the two sequential Values remains a constant 46527, so that the addition of that number on a subsequently intercepted sequential Value might (assuming this is before the User has “used” it by a further authentication) gain access without the fraudster knowing either the Fixed Input or the Fixed PIN separately.

This problem could be solved by a simple algorithm, which would be an instruction to deal with the component parts (Start 27845, Fixed Input 45293 and Fixed PIN 1234) other than merely to add them together. For example, addition of each column in MOD 10 produces the different sums shown above in Col. 2, where the difference is no longer constant: or if the digits are summed other than vertically, even less similarity will appear in the differences. For example, addition on a diagonal basis, as for Col. 3 above, would produce the different results shown i.e. 2+5+2=9, 8+9+4=1, and so on. There are any number of different ways to make separating the total difference between two consecutive Sequential Values into its component parts both essential and more difficult, especially with longer numbers and more inputs. This illustration has been restricted to short numbers to highlight the principles explained.

The particular algorithm used could be changed on a regular basis, even on each occasion of use, provided that both the Master System and the User software had no doubt as to which applied: this could be achieved very simply with software resident on the User's PC, or available through a computer link using for example a Smartcard, to indicate to the User's PC which algorithm applied and to accept the data input from the User via the appropriate algorithm.

3 Variable Data Input

Apart from the Sequential Value, which is always variable, and as a further alternative embodiment of the invention, the input of a fixed PIN together with some variable data, would entirely avoid the problem mentioned in the preceding arrangement, in that the difference between two intercepted set of authentication Codes would not remain the same and comprise too great a variety of elements as to make ascertaining the component parts a difficult if not impossible task. This could be achieved by the arrangement of an array of data onto a “Code card”, which would reside on the User's PC and could also be in physical form. Such a Code card could take many forms, but a convenient method of producing different values on different occasions would be one in which 50 digits (or indeed letters) were arrayed against locator elements corresponding to a Weekday, Date & Month, totalling 50 in all.

Thus, when data is entered by the User from the Code card for the day of use (i.e. the prescribed elements from the Weekday, Day and Month locators) both the Master System and the user would know which data was applicable and no one else could know without seeing a copy of the Code card. As a remote system, this would be quite sufficient: as a physical system, there is the slight chance that the card might be compromised, although the other protection would remain.

The use of letters as well as numbers increases the number of possible combinations for each element of data: for example, the input of three letters based upon a 50 letter array (for convenience as matching the combined totals of Weekdays 7, Date 31 & Months 12) would provide for 50×50×50=125,000 possible combinations whereas 3 numbers has a total of only 1,000.

U.S. Pat. No. 002,013,904 Gardner by the same inventor involves the concept of a Code card and a conversion Table (both of which would be random, different for each User, and could be changed regularly) to locate characters and to enable letters to be converted to numbers for calculation purposes, and possibly for re-conversion to letters. This conversion Table and Code card is taken as being part of the prior art as far as this application is concerned, and as such could be used as a means of producing a variable input to be added to the Fixed inputs to produce the authentication Code as herein described, rather than as a means in itself of producing a variable authentication Code.

The use of a Code card to produce a variable element is not shown further here: it would be as above except that a random element from a Code card would replace the Fixed Input.

4 Longer Codes with Simple Algorithms

Bearing in mind that the simplicity or complication of the Codes and algorithms do not affect the User, the sequential principle may be applied to lengthy numbers, (or indeed to very large number similar to those used in encryption although it seems that this is unnecessary).

Thus a Sequential Value of say 20 2 digit numbers may produce Codes of up to 40 numbers by the input of a combination of various data as outlined above—

For example:—

Registered Credit card number and Card Verification Value

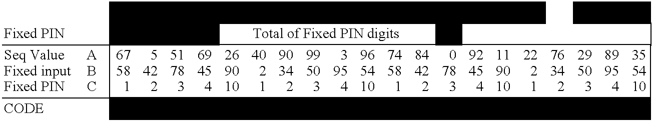

being a simple sum of the elements (with a MOD 100 adjustment) for Sequential Value (infinitely variable, input by User PC at Home or by Download to an Away PC), Fixed Value (from a registered Credit Card, input by the User PC or by the User him or her self into an Away PC), and the Fixed PIN (always input by the User).

From the input data, any number of alternative algorithms may be applied to the 23 input digits and the 40 Sequential digits to produce any number of usable codes of virtually any length, all of which are impervious to attack from a “Home” based PC where the only actual input by the user needs to be the Fixed PIN (all other data—Fixed Input and sequential value being input automatically by the User PC) and the only intercepted data could be the User's authentication Code.

For example, the Table above shows a simple columnar addition with the resultant Codes shown as the bottom line. The authentication Code selected by the system (as previously agreed between the Master System and User) might be:—

[a the whole line of 40 digits 26/49 . . . 88/99

[b the first 20 digits 26/49 . . . 02/60

[c 20 digits beginning with MOD 10 of the preceding last Sequential Value i.e. 35=5^{th}=26/43 . . . 81/41

Insofar as the authentication code sent over an insecure network is less than the whole Code, then some digits forming a part of the next authentication Code are never transmitted.

Where the invention were to be used at an “Away” location i.e. one without the sequential value and algorithm or the Fixed input, then to maintain security the User input would have to be much greater since whatever is downloaded (the sequential value and algorithm together with any Fixed Input data) could be intercepted. Thus, assuming that all data were intercepted by a hostile adversary, the input required by the User has to be such that the number of possible inputs is too large to calculate the missing input i.e. what input imposed on the known starting values and other inputs (assumed to be intercepted) would produce the intercepted authentication Codes/next sequential value. This problem is made simpler if, as shown above, the authentication Code transmitted is less than the full Sequential Value—i.e. although the full starting sequential value may be intercepted, Only a part of the full authentication Code could be intercepted.

The codes that are used will depend upon security and convenience considerations. For example, where the likelihood or cost of fraudulent interception/access were high, then longer codes might be used: if it were low, then shorter codes might be all that is required. It is stressed that the difference in computer power—between shorter and longer Codes—is minute and the difference for the user is probably nil i.e. the input of only a 4 digit fixed PIN may just as easily produce useable 4 or 40 digit codes or longer.

Again for Away situations—without sequential Codes or Fixed Input—the only problem to be solved is the User input values: how portable are the Fixed Values, what if any (preferably nil) memory is required, and how much (if any) should be downloaded for automatic input. Credit card numbers have certain advantages, since:—

[a the numbers are readily and habitually portable, and kept reasonably secure

[b inputting the whole of the numbers is clearly acceptable (as it would be for an online purchase)

[c the numbers are not themselves sent on-line or anywhere—they merely form part of the Code calculation

[d the resultant 23 digit input would require 5 years computation at 1 Million Million calculations per second to test every combination

In fact, the only User input should be the Fixed PIN and that part of the other registered number (e.g. the credit card numbers) as is deemed necessary for Away security—there is little point in downloading fixed data for automatic input. Thus, if a 10 digit input were thought to be enough, then the user would be required to input the Fixed PIN (4 digits) and 6 digits from the Credit Card. This would be easier for the User but far less secure than the whole 19 digits—there are only 10,000,000,000 possible combinations so that the difference could be calculated at 1 Million per second in under a day and almost simultaneously with finishing inputting the test data at 1 Million Million per second.

It could easily be arranged that the download requested say 6 of the Credit card digits to be selected ones and in a certain order, which would involve more concentration by the User but reduce the possibility of successful interception. Thus, amongst other downloaded data (sequential value and algorithm) would be the request:

5^{th} 12^{th} CVV2 15^{th} 2^{nd} CVV1

which from the data used above—Card No. and CVV

| 1 | 2 | 3 | 4 | 5 | 6 | 7 | 8 | 9 | 0 | 11 | 12 | 13 | 14 | 15 | 16 | CVV |
|---|---|---|---|---|---|---|---|---|---|---|---|---|---|---|---|---|
| 5 | 8 | 4 | 2 | 7 | 8 | 4 | 5 | 9 | 0 | 0 | 2 | 3 | 4 | 5 | 0 | 954 |

would mean 7 2 5 5 8 9 being used in the algorithm as a variable input in a predetermined manner.

5. Advance Calculation of Codes: Integrated Identification and Authentication

It is a feature of the present invention that the elements of any particular authentication Code are known in advance: all fixed elements are known anyway and the variable element, the immediately preceding authentication Code, is also (by hypothesis) now known. It would be possible therefore to compute the next authentication Code immediately after this authentication, and this could be done by either or both of the Master System and the User's personal computer entirely separately.

For example, if the next authentication Code is known by the Master Computer, some of the authentication Code could be “posted” as sentinel at the outer barrier firewall: only codes containing the posted element would be allowed “inside” the Master System proper to complete the authentication of the rest of the authentication Code. This has the great advantage for the Master System that hostile denial of service attacks are reduced in effect and incorrect codes (or rather the authors of incorrect codes) are not allowed “inside” at all.

This leads on to a system where a fixed Account number may be avoided: the whole of the next authentication Code may be computed in advance and posted at the firewall as both identification and authentication. Apart from a general tightening of security, such a system would mean specifically that targeted interception of messages or codes would be impossible.

Moreover, since the calculation of the authentication Code can therefore be separated from it being produced, the two (calculation and presentation) need not bear any particular resemblance to each other which has advantages in relation to Key Management of data and Fixed PINs.

6. Fixed PIN and Sequential Authentication

The role of a Fixed PIN in authentication is generally limited to proving that the other data has been input by the correct person, or at least by one who knows the Fixed PIN. As such the Fixed PIN is normally allocated by the Master System to a User, although it may normally be changed very easily. In some cases, the Fixed PIN unlocks something else (e.g. a Token or a PC) which itself then provides or submits the authentication Code.

With the present invention of Sequential Authentication, the impact of the Fixed PIN, although crucial, is less than is usual, partly because of the length of the Codes and partly because of their variable nature. Accordingly the Fixed PIN is more the catalyst to galvanise the system into producing a variable authentication Code: given the input of a Fixed PIN, the system would produce authentication Codes for submission using the data including the sequential value, Fixed Values and the Fixed PIN.

The User system may be set to allow only correct authentication Codes to be submitted, implying that the user programme knows the Fixed PIN with consequential risk (however slight) of it being prised out of the computer, or to submit Codes whether right or wrong with possibly (if the computer did not know the Fixed PIN) no means of finding out. This latter arrangement would require that at least a part of the authentication Code be posted at the Outer firewall barrier since otherwise any input submitted would have to go “inside” to be checked, clearly a riskier business than is desirable.

In a further embodiment of the invention, as another result of the fact that the next authentication Code can be calculated now, it is possible for neither the User system nor the Master System to know what the Fixed PIN is, although it would be an essential ingredient of any correct authentication Code prepared by the User. This may be achieved only with sequential authentication, with its infinitely variable Codes, by arranging for the next authentication to be calculated (by both user and Master Systems) during this authentication (the authentication Code for which would have been computed whilst authenticated on the previous occasion, and so on) without any Fixed PIN element in the calculation, and then arranging for the authentication Code so calculated to be

[a posted at the Master System outer barrier firewall

[b “reduced” by the Fixed PIN (as just input by the User for this authentication) and the resultant reduced Code recorded on the PC and data-carrying card

[c but not recorded by the PC or data-carrying card and forgotten (the Master System would never know what it was)

On the next authentication, the User would input his or her Fixed PIN which would be “added” to the reduced Code to then produce the correct authentication Code, following which the process would be repeated for the next following authentication.

In this preferred embodiment of the invention, since the Fixed PIN would not be used in computing the authentication Codes at all, the calculation would be entirely unconstrained and could in fact be anything at all. When the next Code had been computed, the Fixed PIN would be used to disguise the Code on the User's PC (say to “reduce” it) but in such a manner that the input of the correct Fixed PIN plus a simple algorithm (to “add” the Fixed PIN back again) then produced authentication Codes matching those at the Firewall, with the Master System never knowing the User's PIN at all. Thus the problem of “key management” would be entirely avoided by the Master System: the setting of a Fixed PIN would be entirely the responsibility of the User, within the constraints of the relevant programme (for example no zero at front, no figure repeated twice consecutively, etc.)

The Fixed PIN might be known to the User PC and the Master System or by neither. The programme would ensure that on the user inputting the Fixed PIN, the current authentication Code would be calculated, submitted, found to agree with that on the Firewall and the next authentication Code thereby also calculated and posted ready for the next occasion, and the User would then record the reduced sequential value which, on the subsequent addition of the Fixed PIN would then produce the correct authentication Code.

7. Check Authentication Codes

In a further embodiment of the invention, a series of sequential values could be used for authenticating checks written otherwise in a conventional fashion but including a variable authentication Code endorsed thereon. The construction of the variable PIN would be similar to those described above, an amalgam of fixed inputs including a Fixed PIN, and random inputs being the previous sequential value and possibly the check number. In addition, the amount of the check itself could easily be included as authentication of a further aspect of the check if required.

The system would, unusually, operate off-line, with the check writer using a personal computer to work out the next relevant authentication Code. From time to time, the sequence could be changed by a random input generated by the bank but this should not be necessary in view of the differing inputs for check number and possibly check amount.

For Users making large numbers of check payments in an automated fashion, such a system could be integrated with the check writing facility and enhance direct liaison of the bank with the User by providing for the authentication of electronic transactions instead of merely being notification by electronic means. Such a system would very greatly enhance the security of check payments since it would be simply impossible to forecast what a sequential value might be and there would be no Internet or other message to intercept.

The truncation of checks—the restriction of the checks' physical movement to the receiving bank (i.e. where the check first enters the banking system) followed by electronic transfer thereafter—is greatly enhanced by the receiving bank also being the paying bank. Whilst this is encouraged already, the additional incentive of a positive authentication of a check by a variable authentication Code in what could be an entirely automated process as the checks enters the banking system would greatly decrease check fraud.

8. Computer to Computer/device Authentication

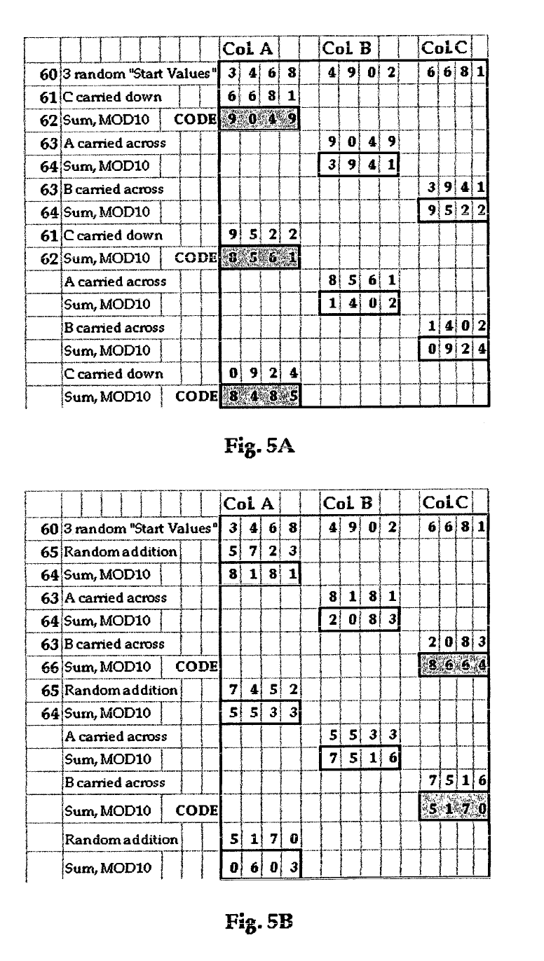

The present invention also lends itself to a system for mutual continuous authentication whereby each authentication Code transmitted is a sequential function of the immediately preceding authentication Code plus a factor added on each occasion by each computer or device, without any need for a Fixed PIN input (or indeed a “User” at all in the case of computer to computer or device to device). These are illustrated further at FIG. 5

A data-carrying card—e.g. a Smartcard or a Magnetic Stripe card—may also be continuously authenticated in this manner, either by having its own separate sequential function (of which the User knows nothing) or by using the authentication Codes of the User to simultaneously authenticate that User and the card itself.

In this manner, the integrity of a computer, device or card may be enhanced and fraudulent replication of a card very much more difficult. At the very least, the system would severely limit the window of opportunity for any fraud to be committed as a card could not be used unless it had the correct sequential value

9. Amalgamation of Features: Random Sequential Authentication

By amalgamating various features dealt with above, it would be possible to provide for integrated identification and authentication using a sequential function and a random value generated by the Master System during one authentication as required input for a later authentication, with this random value sent over the network in advance to the User's PC.

Thus, illustrated is a generated Code of 40 digits consisting of 20 digits authentication Code and a further 20 digit random Code. The next authentication Code would be the last Code plus the unused Code brought down i.e. 67 plus 74 brought down=41 (all columnar additions being MOD100). The resultant authentication Code 41/89 . . . 46/77 would then be submitted and if authenticated, the Master System would generate a new 20 digit entirely random Code—94/25 . . . 56/96 which would affect the next but one authentication Code. The next Code would be the sequential value 41/89 . . . 46/77 plus the previously calculated and now brought down 8134 . . . 13/66 leading to 49/23 . . . 68/11.

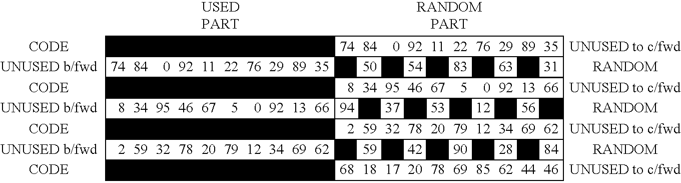

The value 08/34 . . . 13/66 was in turn the sum 0f the codes 74/84 . . . 89/35 and an entirely random factor of 34/50 . . . 24/31. Thus the right half shown above would constitute a separate sequential function to which random values would be continually added, and which would provide the variable data addition to the authentication Code sequence proper on the left side.

The input by the user would be just a self-set fixed PIN, with an additional Fixed data value being included to ensure that any Codes intercepted could not be distinguished and would be of no value.

The overall position is illustrated below:

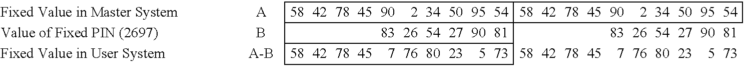

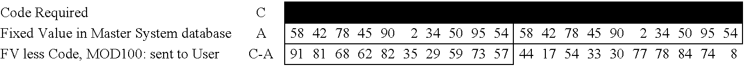

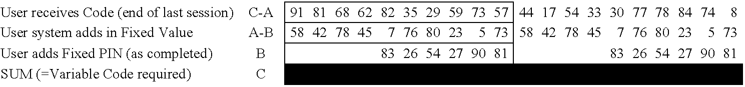

Thus:

[1Fixed data value: in Master System database A but in User system reduced by value of Fixed PIN (2697) which translates from the algorithm applied to it to be B: producing A−B=Fixed Value in the User system.

[2The Master System sends Code values C−A to the User i.e. the Code required C less the total Fixed Data value A=C−A

[3The User enters the Fixed PIN B (2697, translated as 83/26 . . . 90/81 by the relevant algorithm) and the User system enters the reduced Fixed Data Value A−B

[4The User system adds the Code received C−A+A−B+B=C=required Code

On authentication, the new Code C−A is downloaded, the Fixed Data and Fixed PIN values are deducted and then the latter is forgotten: only the reduced Code value and the reduced Fixed data value are recorded.

The Fixed PIN value of 83/26 . . . 90/81 would extend to say 6 figures (12 digits): the remaining authentication Code values would not be affected by the Fixed PIN and would be merely sequential, so that at least it would be possible to show that the User had the correct sequential value even if he or she had forgotten the Fixed PIN, leading to separate authentication using other registered data. These purely sequential values could be at the front or the end of the authentication Code—a balance between assisting identification (front) or increasing interception avoidance (the end).

Such a system would provide integrated identification and authentication which would be impossible to penetrate in view of the continual input of entirely random digits, but without any Key Management problems as the Fixed PIN input would be User-set and controlled. It could be used at a PC or with a data-carrying card: the latter would need about the same memory as a train or bus ticket, and certainly less than a Credit card, as it would not know its own PIN, merely having a Fixed Data Value (the reduced User Fixed Value, as reduced by the now-forgotten Fixed PIN) and the last sequential value recorded at the time of the last authentication.

10. Biometric Enhancement

The power of a Biometric system (including fingerprints, facial or iris scan, etc.) for physical identification and authentication is unarguable, but it is not universally used for authentication generally (as yet at least) because of various factors including cost, reliability and its restriction to physical use. To improve the reliability (to reduce the False Acceptance Rate and the False Rejection Rate to acceptable levels, ideally nil) is expensive and not all systems can justify such an expense.

Moreover, the Biometric data turns out to be just another digital value (albeit possibly long and very precise) when it comes to remote transactions, subject to the very problems the present invention is designed to circumvent.

If therefore a Biomtric value were taken as an input to replace the Fixed PIN, then provided the Biomtric data can be interpreted as set out below, the strengths of both systems (Biometrics and the present invention) could be joined together to produce a three factor authentication. Thus, at physical locations, the strength of the Biometric would be enhanced by the value of the sequential system as set out in this application, whereas in remote situations, the digital value of the Biometric (which may safely be stored in a “Home” location) would replace a fixed PIN in the previous illustrations and generate a sequential value as shown.

The interpretation of the data required is the opposite of what is conventionally required—very precise Biometric values where to approach 100% accuracy involves perhaps a very long digital code and is expensive—and is that the data can produce a 99.9% accurate low precision value of say 4 to 6 digits where there is therefore no False Rejection, False Acceptance being covered by the sequential code system of the present invention. Such an interpretation is assumed to be very much less expensive than the more precise system usually sought.

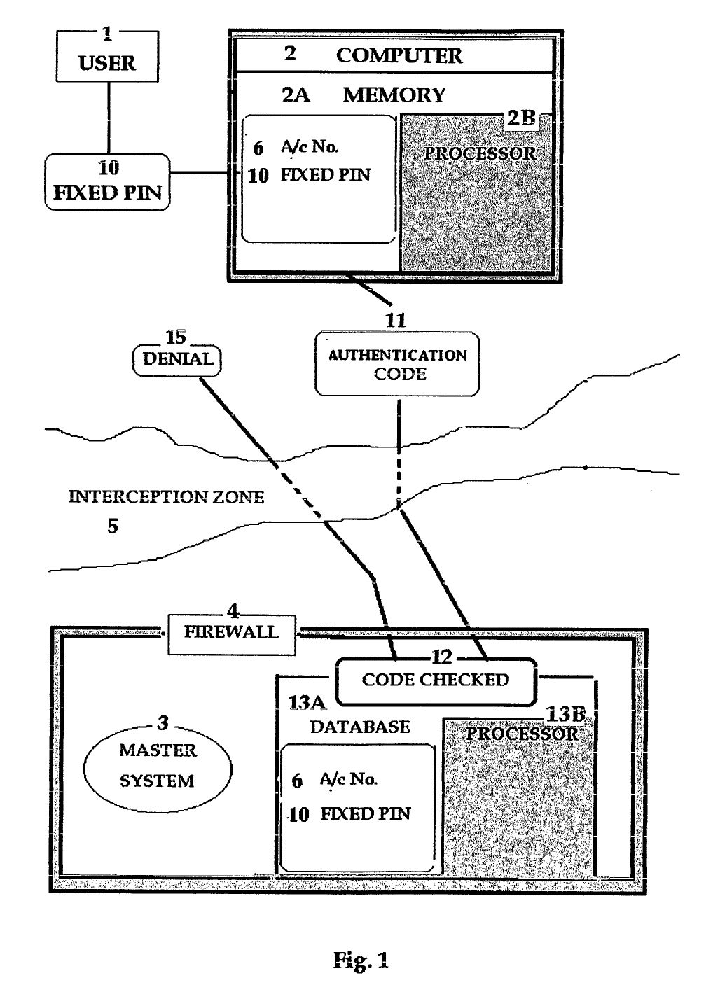

FIG. 1 shows an arrangement for the remote authentication of a User 1 with a Computer 2 with Memory 2A and Processor 2B connected (by direct link, telephone or radio) to a Master System 3 which consists of a Database 13A and Processor 13B, with many other parts not germane to this description. The Master System 3 is protected by a Firewall 4 which has the ability to verify and let pass certain electronic messages or to turn away other messages, depending in each case upon the configuration of the Firewall 4 and the requirements of the Master System 3

One significance of the Firewall 4 is that it could help to prevent a Master System 3 being overwhelmed by messages necessarily allowed inside for checking, either generated through a surge of interest or by a denial of service attack-one provoking a high level of traffic with hostile intent.

To authenticate him or her self, a User 1 may enter a Fixed PIN 10 into the Computer 2, which in one of various ways enables the Computer 2 to send the correct Authentication Code 11 to the Master System 3, the most usual method being that the Fixed PIN 10 entered is the same as the Fixed PIN 10 recorded in the Memory 2B which thereby allows the Authentication Code 11 to be released. The Authentication Code 11 is usually a fixed message consisting of an Account Number 6 together with a password or possibly the Fixed PIN 10 itself. If encryption is used in view of the dangers of a Fixed Authentication Code 11 passing over an Interception Zone 5, then it has to be allowed inside past the Firewall 4 for checking.

In more complex systems, usually involving a Token or Device, the Fixed PIN 10 is entered into that Token or Device which then calculates a variable Authentication Code 11 which has to be entered by the User 1 into the Computer 2 for sending to the Master System 3.

The similarity of the present invention and the Token/Device system mentioned above is restricted to the fact that the signal in both is variable: the Token/Device system does not allow for Reciprocal Authentication, the signal is not known in advance so that integrated identification and authentication is not possible, and the Authentication Code 11 necessarily has to pass straight through the Firewall 4 otherwise it could not be checked.

The Authentication Code 11 is sent down the linkage medium (direct line, telephone or radio) where it is assumed that it has to cross an Interception Zone 5 area where interception by hostile third parties is possible, and arrives at the Master System 3 where it either passes through the Firewall 4 for verification inside or is Checked 12 at the Firewall 4 before being allowed entry. In either case, at least some aspects of the Authentication Code 11 will be checked at the Firewall 4, even if it is only to check the number of digits and the Account Number 6 part being within set limits for characters and length.

The Authentication Code 11 will be Checked 12 against the Database 13A and if incorrect will generate a Denial 15 if correct, the Master System 3 will allow access to the appropriate data in the protected system (within the Master System 3 or elsewhere) appropriate to the User 1, possibly although not necessarily passing a message to the User 1 confirming authentication. Actual (or as the case may be, apparent) access would usually be sufficient—the User 1 is thought not to need a message as they have (or at least appear to have) system access, and there is in the prior art no means of verifying to the User 1 that it is the correct connection apart from the Master System 3 merely asserting that it is so.

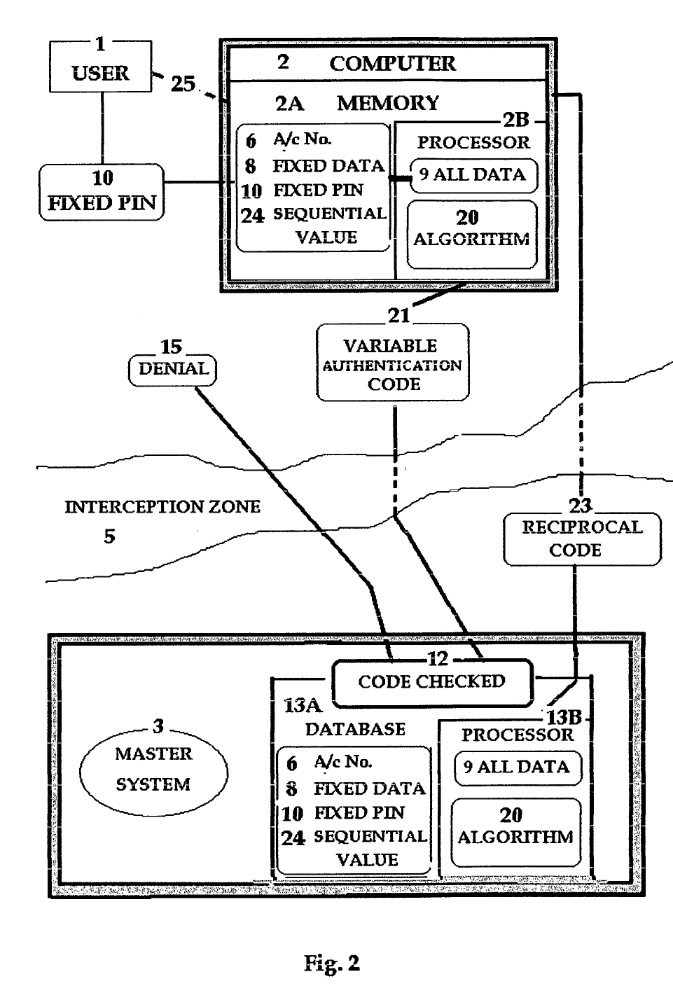

FIG. 2 shows a similar arrangement for the remote authentication of a User 1 with a Computer 2 connected to a Master System 3 as in FIG. 1 except that the present invention is taken to be the means of authentication Code generation and verification.

There are various differences between a conventional authentication as in FIG. 1 and one using the present invention as shown on FIG. 2. The principal one is that the Variable Authentication Code 21 is variable and differs on each and every occasion of use, calculated by the Computer 2 by reference to data held in Memory 2B together with the input Fixed PIN 10. The factors in the calculation of the Variable Authentication Code 21 for each use are the Account Number 6, Fixed Data 8, the Fixed PIN 10 and most important of all the Sequential Value 24.

The Sequential Value 24 is by definition a variable input which is of similar length to the Variable Authentication Code 21, and together with the other elements above is subject to an arithmetical or mathematical “mixing” by the Processor 2B using the prescribed Algorithm 20. The details of the Algorithm 20 are not specific to the present invention: provided that the various elements are “mixed” in a manner that cannot be easily discovered and where the outcome is an infinitely Variable Authentication Code 21, and provided that it is possible, knowing the Fixed PIN 10 and All Data 9 input elements, to produce a specific predetermined Variable Authentication Code 21, which cannot easily if at all be reproduced, then the Algorithm 20 would be acceptable. The difficulties of trying to predict a Variable Authentication Code 21 are determined mainly by the quantum of inputs, not the Algorithm 20

Having computed the Variable Authentication Code 21, it is sent to the Master System 3, passing Interception Zone 5 on the way. However, here the interception of an Variable Authentication Code 21 will not be of benefit to a third party by itself: it would not by definition be useable again and its only value might be as a base from which to try and calculate what the next Variable Authentication Code 21 for a particular User 1 might be. This could only be achieved by targeting a particular User 1, noting consecutive Variable Authentication Code 21's and attempting to compute in advance what the next consecutive Variable Authentication Code 21 would be.

With the length of Codes envisaged, the number of possible ways of producing a known Variable Authentication Code 21 from the immediately preceding Variable Authentication Code 21 (and it would have to be the immediately preceding Variable Authentication Code 21 and not an earlier one with a gap in between, implying dedicated continuous monitoring) is too great for present computation. In any event, given input digits of say 50 and a Variable Authentication Code 21 of 40, there would be very many different ways of producing the correct Variable Authentication Code 21 but no way of finding out which was correct without submitting it to the Master System 3.

The Master System 3 receives the Variable Authentication Code 21 and replicates the code computation set out above—by applying the Algorithm 20 to All Data 9 input including the Sequential Value 24, and will generate either a Denial 15 or Reciprocal Code 23, the latter being based upon the Variable Authentication Code 21 and derived from it. A value equal to the Reciprocal Code 23 will have been generated onscreen on User 1's Computer 2 immediately after the input of the Fixed PIN 10 by the User 1, and thus the receipt of a Reciprocal Code 23 by the User 1 from the Master System 3 will constitute Visible authentication 25 of the Master System 3 to the User 1.

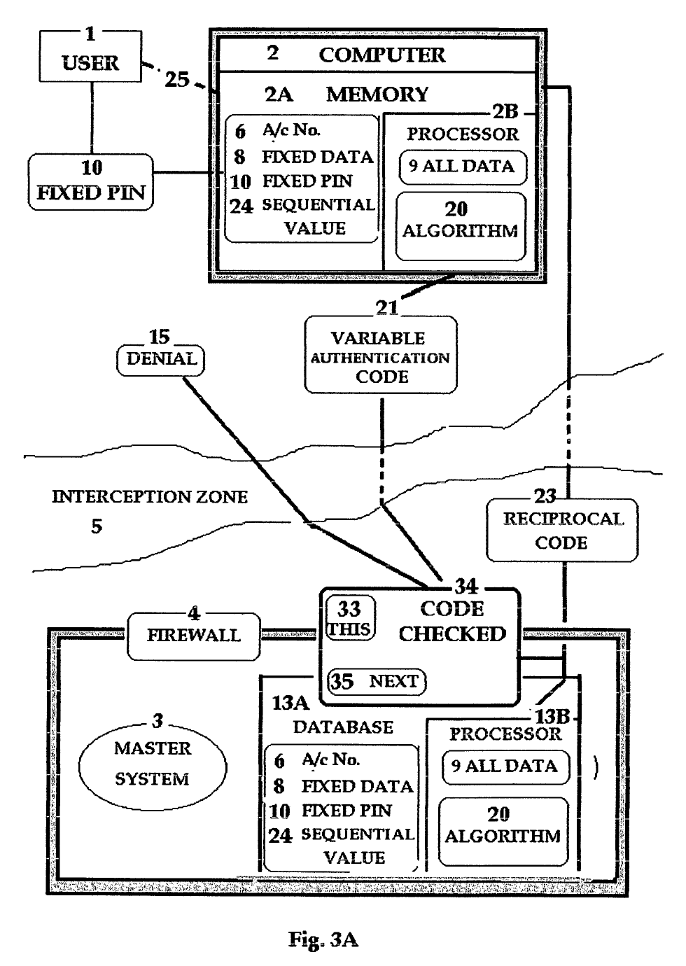

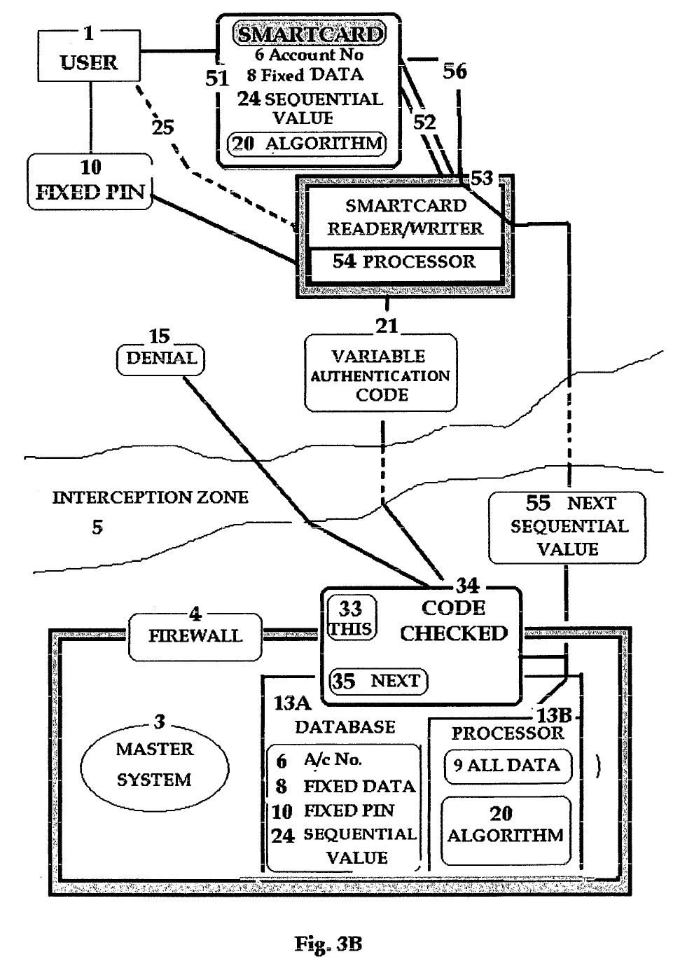

In FIG. 3A, a similar arrangement for remote authentication exists as in FIG. 2 except for an important difference on timing.

In FIG. 2, both the User 1 and the Master System 3 computed the Variable Authentication Code 21 in real time, the User 1's Computer 2 on input of the correct Fixed PIN 10 and the Master System 3 on receipt of a Variable Authentication Code 21. However, after this Variable Authentication Code 21 has been authenticated, the next Variable Authentication Code 21 could then be computed as all of the factors are by then known. To emphasise this point, all authentication Codes are sequential and given unchanged input data could therefore be computed in advance.

It is possible therefore for the User 1's Computer 2 and the Master System 3 (after authentication using the All Data 9 input, the Fixed PIN 10 and the Sequential Value 24, as shown and as in FIG. 2) to compute the Next 35 Variable Authentication Code 21 and to post all or part of this at the Firewall 4 for verification prior to allowing the next following attempted authentication inside the Firewall 4. Moreover, since each User 1's Next 35 Variable Authentication Code 21 could be posted at the outer barrier Firewall 4, it would be possible to dispense with the Account Number 6 as a part of the Variable Authentication Code 21, so that integrated identification and authentication could be achieved in a secure manner not previously available. The Next 35 Variable Authentication Code 21 would be checked at the Firewall 4 and compared with values already posted there for each User 1, with a direct switch to the User 1's account if authenticated and a Denial 15 if not.

FIG. 3B illustrates the invention where the User 1 is away from his or her usual Computer 2 and therefore requires a means of carrying the required data—the Fixed Data 8, the Algorithm 20 and the Sequential value 24.

This may be achieved by using an IC Chip Smartcard 51 which carries with it all necessary data for computing a Variable Authentication Code 21 except for the Fixed PIN 10 which is as usual required input.

The User 1 Inserts 52 the Smartcard 51 into the Computer 53 (which is both a card reader and a Processor 54): taking both data and instructions from the Smartcard 51, it relays the Variable Authentication Code 21 to the Master System 3 as in FIG. 3.

Assuming authenticated, the message Reciprocal Code & Sequential Value 55 is then sent back to the Computer 53, from which the standard Visual confirmation 25 is displayed and also the new Sequential Value 24 is written to the Smartcard 51 for the next occasion.

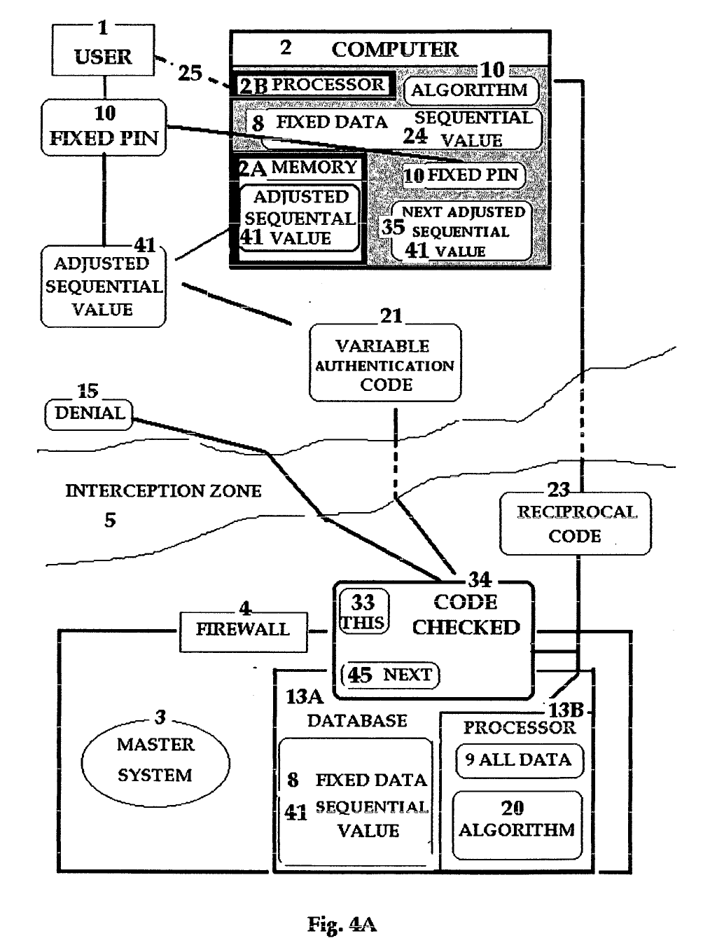

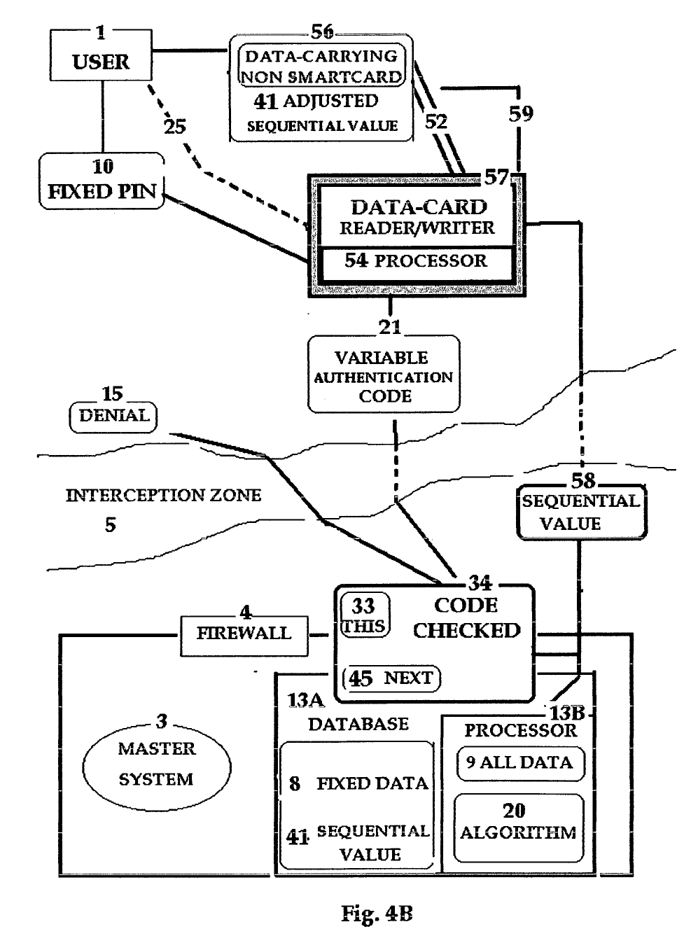

FIG. 4A illustrates a different order of events to those described in FIG. 3, which predicates that when the User 1 next wished to use the system, he or she enters a Fixed PIN 10 into the Computer 2 so that the next Variable Authentication Code 21 may be computed and submitted (even though the Master System 3 may have already computed it and posted it at the Firewall 4). In FIG. 4, it is assumed that during this authentication (i.e. having just authenticated a Variable Authentication Code 21), on receipt of the correct Fixed PIN 10, the Computer 2 calculates the Next 35 Variable Authentication Code 21, “adjusts” it with the Fixed PIN 10, and remembers this Adjusted Sequential Value 41 ready for the next authentication occasion.

The adjustment referred to is that the Computer 2 applies some simple reversible arithmetic function to the Fixed PIN 10 and the Sequential Value 24 to arrive at the Adjusted Sequential Value 41: for example, the Computer 2 may deduct the Fixed PIN 10 from the Sequential Value 24 to form the Adjusted Sequential Value 41, which then resides on the Computer 2. When the User 1 subsequently enters the Fixed PIN 10 into the Computer 2, the Fixed PIN 10 would be added to the Adjusted Sequential Value 41 to make the current required Variable Authentication Code 21 which is then submitted to the Master System 3, passing through the Firewall 4.

The Variable Authentication Code 21 may have been computed by the Master System 3 and posted at the Firewall 4 as in FIG. 3.

By itself, the calculation of the Adjusted Sequential Value 41 from the Sequential Value 24 is no particular improvement: the Variable Authentication Code 21 is unchanged and computed in advance as before. However, if the Algorithm 20 used to compute the Variable Authentication Code 21 did not use the Fixed PIN 10 as a factor, it would be possible to have a PIN-protected system where neither the User 1's Computer 2 or the Master System 3 knew what the Fixed PIN 10 was, it being entirely User 1 set and controlled.

Similar to the basic invention itself, this is best explained after the ftrst occasion i.e. assuming a correct authentication now and before logging off:

[a both the User 1's Computer 2 and the Master System 3 compute the Next 35 Variable Authentication Code 21 using the Algorithm 20 on the Fixed Data 8 and the Sequential Value 24 excluding the Fixed PIN 10

[b the Master System 3 posts this Next 35 Variable Authentication Code 21 at the Firewall 4

[c the User 1's Computer 2 “reduces” the Next 35 Variable Authentication Code 21 by the value selected by the User 1 as a Fixed PIN 10, producing an Adjusted Sequential Value 41

[d when on the next occasion the User 1 inputs the same Fixed PIN 10, the Computer Processor 2B “adds” the Fixed PIN 10 (i.e. reverses the previous step) and produces the correct Variable Authentication Code 21, but not otherwise i.e. only the correct Fixed PIN 10 will produce the correct Variable Authentication Code 21 even though it is not recorded by either the Computer 2 or the Master System 3 and was not used in Code computation.

By this means, the Master System 3 may largely or entirely avoid “Key Management” problems, and PIN recovery would then amount to satisfying the Master System 3 that the person claiming to be a User 1 was indeed so by using other registered data.

FIG. 4B illustrates a portable system using the configuration set out above for FIG. 4, where a Smartcard is not required and a very unintelligent Magnetic Stripe card would suffice, since all that is recorded is the Adjusted Sequential value 41. If not an integrated identification/authentication system, an Account Number 6 would also be carried.

The User 1 Inserts 55 the Data Card 56 into a Data reader 57 with Processor 54 capacity only insofar as it is needed to send a signal, receive another and record the latter on the Data card 56. Thus, the signal sent is the Variable Authentication Code 21 found after adding the Fixed PIN 10 just input by the User 1, and the return signal is the new Sequential Value 58. The Processor 54 then deducts the Fixed PIN 10 (in temporary memory from its input by the User 1) to find the new Adjusted Sequential Value 41, writes this to the Data card 56 and then forgets everything except this new Adjusted Sequential Value 41 and that it has to add an input Fixed PIN 10 next time.

All Variable Authentication Code 21 computations are therefore carried out on the Master System 3 and the Data Card 56 merely acts as a means of producing the correct Adjusted Sequential Value 41 and to complete the Variable Authentication Code 21

FIG. 5 illustrates the means by which the sequential values produce continual Variable Authentication Code 21 with no further input after the start (FIG. 5A) or with regular random inputs (FIG. 5B). The “algorithm” illustrated is for the sake of clarity merely simple addition to a MOD 10 base: the invention is intended to cover all forms of arithmetical or mathematical computation (or algorithm).

In FIG. 5A, both a Computer 2 and a Master System 3 have in Memory 2A/13A three Random Start Values 60. The value for Column C is carried down 61 to Column A, and added to its Start Value 60 it to make a Code 62 (equivalent to a Variable Authentication Code 21). This Code 62 is then carried across 63 to Col. B and added to its Start Value 60 to make the Value 64, carried across 63 to Column C as value 64.

This Value 64 is added to Col. C's Start Value 60 to produce Value 64, in turn carried across 61 to Col. A as Code Value 62, where the process is repeated.

Both User 1 and Master System 3 retain all sets of figures, although Column A is the equivalent of the User 1's calculations to produce a Variable Authentication Code 21 whilst Columns B and C are the equivalent of Master System 3 maintaining a constant supply of variable Values 61

FIG. 5B is similar except that Columns B and C equates with the User 1 and Column A represents the Master System 3 producing a truly random Value 65 on each occasion: again, both may mirror all calculations except that the User 1 has to await the Random Value 65 before it can produce the required Variable Authentication Code 21 for each authentication

Both FIGS. 5A and SB relate to systems where the Next 35 Variable Authentication Code 21 is computed in advance, which makes the use of a truly random Code 65 possible. Moreover, although the random number may be thought of as dominant, the fact remains that the correct Variable Authentication Code 21 would still not be produced without all other inputs (here only the Sequential Value 24) also being correct.

The present invention presents various aspects based upon a sequential function as a means of authentication, from a low value automated continual verification process or for micro payment systems authentication, to entirely secure systems using truly random codes with integrated identification and authentication. In this latter system, all current problems have been to a large extent avoided, excepting only the danger of Fixed PIN carelessness, and even that largely neutralised by the sequential function. If instead of a Fixed PIN a Biometric function were employed to produce a positive 4 digit (minimum) fixed input, then 3 factor authentication of the highest possible security would be achieved and Biometrics would achieve a complementary system for remote authentication whereby its reliance upon the security of a lengthy digital value may be avoided.

I claim:

1 A method and apparatus for the authentication of a person registered in a system to the Controller of that system by means of authentication Codes which are characterised by being variable for each occasion of use, the authentication Codes being derived from the input by the person of predetermined specified fixed and variable data, the fixed data including an identifying account number and the variable data being derived from randomly generated characters communicated for the purpose to that person by the Controller of the system for use on the first occasion of authentication and thereafter derived in part as a sequential function of the immediately preceding authentication Codes used by that person, with in each case a treatment of the data input serving to mix the elements in a manner whose outcome is known only to the person and the Controller of the system.

2 A method and apparatus for authentication as in claim [1 with further provision for the sending by the Controller to the person, subsequent to a validated authentication Code submitted by that person, of a reciprocal authentication Code being a separate code derived from the same data and the same treatment as produced the validated authentication Code identified beforehand and known only to the Controller and the person, and thereby reciprocally authenticating the Controller to that person.

3 A method and apparatus for authentication as in claim [2 and further providing for digitasl certification of a person wherein such a person may pass an authentication Code together with the reciprocal authentication Code to be expected to a third party who may then send such authentication Code to the Controller and by receiving from the Controller the expected reciprocal authentication Code subsequent to validation of the original authentication Code be satisfied that the person is in fact registered with the system

4 A method and apparatus for authentication as in claim [2 wherein the input by the person includes at least one character from a set of at least two fixed characters remembered by the person and registered with the Controller as a means of Fixed Personal Identification (“FPI”),

5 A method and apparatus for authentication as in claim [4 wherein the input by the person further includes fixed data consisting of 1 or more characters derived from material in the possession of the person which is capable of being carried personally and which is not publicly available

6 A method and apparatus for authentication as in claim [5 wherein the material in the possession of the person consists of any Credit or Debit Card registered by the person with the Controller for the purpose, and wherein the data to be entered is 1 or more digits from that Card, as previously specified and agreed between the person and the Controller without the need of further specific direction on any subsequent occasion

7 A method and apparatus for authentication as in claim [6 wherein the predetermined specified fixed and variable data is recalled on a personal computer and entered automatically by the personal computer on an attempted authentication on the input by the person of a FPI of more than 1 character

8 A method and apparatus for authentication as in claim [7 wherein most of the predetermined specified fixed and variable data is held on a portable card capable of interacting with a computer and having facilities for reading and recording data and for inputting data from memory into that computer by means of a card reader attached to the computer on the input by the person of the remaining required data including a FPI of more than 1 character

9 A method and apparatus for the authentication of a person registered in a system to the Controller of that system by means of authentication Codes which are characterised by being variable for each occasion of use, the authentication Codes being derived from the input by the person of predetermined specified fixed and variable data, the fixed data including an identifying account number and 1 or more digits from a Fixed Personal Identification (“FPI”) remembered by the person and registered with the Controller and the variable data being derived from randomly generated characters communicated for the purpose to that person by the Controller of the system for use on the first occasion of authentication and thereafter derived in part as a sequential function of the immediately preceding authentication Codes used by that person, with in each case a treatment of the data input serving to mix the elements in a manner whose outcome is known only to the person and the Controller of the system, and further characterised by the provision by the Controller, subsequent to a validated authentication Code submitted by that person, of a reciprocal authentication Code being a separate code derived from the same data and the same treatment as produced the validated a separate code derived from the same data and the same treatment as produced the validated authentication Code, identified beforehand and known only to the Controller and the person, and thereby reciprocally authenticating the Controller to that person.

10 A method and apparatus for integrated identification and authentication as in claim [9 wherein the fixed data does not include an identifying account number with identification being obtained from the variable authentication Code itself, and which is computed in advance by the Controller from the known fixed data and the immediately preceding authentication Code, the resulting authentication Code being used for both identification and simultaneous authentication.

11 A method and apparatus for the authentication of a person registered in a system to the Controller of that system comprising the following steps
[a the registration of a person with the Controller of a system
[b the allotment of an account number to the person
[c the agreement between the person and the Controller of fixed data elements and of the arithmetical and other processes to be applied to input data
[d the registration with the Controller of a Fixed Personal Identification (“FPI”) selected by the person
[e the transmission by the Controller to the person of a starting value, consisting of a series of random digits or letters, in a secure manner as practised in the art
[f the transmission by the Controller of software for computing the authentication Codes and in particular for remembering the sequential value of the preceding authentication Code
[g on the first occasion of use, the input by the person of the fixed data, the starting value and the FPI into a personal computer where the input data is subject to arithmetical and other processes from which is derived the variable authentication Code
[h means for submitting the authentication Code together with an identifying account number to the Controller for authentication or rejection
[i means for remembering the authentication Code for use as a sequential value in the next authentication Code calculation
[j on the second and subsequent occasions of use, the input by the person of the FPI and the automated input by the personal computer of the fixed data and of the immediately preceding authentication Code as a random variable and wherein the input data is subject to arithmetical and other processes from which is derived the variable authentication Code
[k means for submitting the authentication Code together with an identifying account number to the Controller for authentication or rejection
[l means for remembering the authentication Code for use as a sequential value with the next authentication Code calculation
[m means for transporting the sequential values and other fixed values where the person wishes to be authenticated away from the personal computer wherein most of the fixed and variable data is held on a portable data carrying card capable of interacting with a computer and having facilities for reading and recording data and for inputting data from memory into that computer by means of a card reader attached to the computer on the input by the person of the remaining required data including a FPI of more than 1 character

12 A method and apparatus for authentication as in claim [11 wherein the next authentication Code is computed by the Controller in advance with at least a part of the next variable authentication Code being available at the system 's outer barrier firewall, to prevent access inside the firewall to unauthorised intruders and to allow access only to persons presenting the anticipated authentication Code at the system outer barrier firewall

13 A method and apparatus for integrated identification and authentication as in claim [12 wherein the fixed data does not include an identifying account number with identification being obtained from the variable authentication Code which is computed in advance by the Controller from the input fixed data and the immediately preceding authentication Code, the resultant authentication Code being used for both identification and simultaneous authentication.

14 A method and apparatus for authentication of a person registered in a closed system to the Controller of that system comprising the following steps
[a the registration of a person with the Controller of a system
[b the allotment of an account number to the person
[c the agreement between the person and the Controller of fixed data elements and of the arithmetical and other processes to be applied to input data
[d the transmission by the Controller to the person of a starting value, consisting of a series of random digits or letters, in a secure manner as practised in the art
[e the transmission by the Controller of software for computing the authentication Codes and in particular for remembering the sequential value of the preceding authentication Code
[f the person registering on his personal computer a Fixed Personal Identification (“FPI”) known only to the person and not registered with or known by the Controller
[g the person's personal computer calculating as if on the first occasion of use the result of the arithmetical and other processes applied to the notional input by the person of the combination of the fixed data and the starting value, deducting from the resultant variable authentication Code an arithmetical function of the FPI known to the personal computer and recording the resultant code on to the personal computer
[h separately the Controller calculating as if on the first occasion of use the result of the arithmetical and other processes applied to a notional input of the combination of the fixed data and the starting value, and recording the resultant variable authentication Code at least in part on to the system's outer barrier firewall
[i on the first occasion of use, the input by the person of the FPI into a personal computer where the arithmetical and other processes are applied to the resultant code in reverse, producing the pre-computed required variable authentication Code
j further, as if on the second occasion of use, the person's PC repeating the process from [g but substituting the just determined variable authentication Code for the starting value referred to at [d and deducting from the resultant variable authentication Code an arithmetical function of the FPI known to the personal computer, and recording the resultant code on to the personal computer
[k means for submitting the authentication Code determined in [i together with an identifying account number to the Controller
[l means for the Controller comparing the code submitted at [k with that calculated at [h and authenticating or rejecting the authentication Code as the case may be
[m subsequently, the Controller calculating as if on the next occasion of use the result of the arithmetical and other processes applied to the notional input of the combination of the fixed data and the just used authentication Code, and again recording the resultant variable authentication Code at least in part on to the main system's outer barrier firewall
[n on the second occasion of use, the input by the person of the FPI into a personal computer where the arithmetical and other processes are applied to the resultant code in reverse, producing the pre-computed required variable authentication Code further, as if on the third occasion of use, repeating the process from [j but substituting the just determined variable authentication Code for that in [j and deducting from the resultant variable authentication Code an arithmetical function of the FPI known to the personal computer, and recording the resultant code as 3^{rd} authentication Code on to the personal computer [p means for the Controller to repeat [l and [k on the 2^{nd} and as if on the 3^{rd} occasion of use and so on
[q means for the person to repeat [n and [o on the 3^{rd} and as if on the 4^{th} occasion of use and so on
[r means for transporting the sequential values and other fixed values where the person wishes to be authenticated away from the personal computer wherein most of the fixed and variable data is held on a portable data carrying card capable of interacting with a computer and having facilities for reading and recording data and for inputting data from memory into that computer by means of a card reader attached to the computer on the input by the person of the remaining required data including a FPI of more than 1 character

15 A method and apparatus for integrated identification and authentication as in claim [14 wherein the fixed data does not include an identifying account number with identification being obtained from the variable authentication Code which is computed in advance by the Controller from the known fixed data and the immediately preceding authentication Code, the authentication Code being used for both identification and simultaneous authentication.

16 A method and apparatus for the mutual continuous authentication of one computer terminal linked to another by means of a continuous series of authentication Codes in which each such authentication Code apart from the first is a sequential function of the preceding authentication Code and which therefore varies on each occasion, by means comprising
[a first computer generating a random value A and a fixed value B, and communicating both to second computer in a secure manner as practised in the art
[b second computer generating a fixed value C and communicating it to first computer in a secure manner as practised in the art
[c first computer using an arithmetic or other function on the random value A and fixed value B, and sending this resultant sequential authentication Code P to second computer
[d second computer:
[i receives sequential authentication Code P from first computer
[ii performs the same arithmetical or other function on the first computer's random value A & fixed value B to check the validity of the first computer's sequential authentication Code P
[iii if authenticated, using the same arithmetical function on the second computer's fixed value C and the sequential authentication Code P just received resulting in sequential authentication Code Q
[iv sends the sequential authentication Code Q to first computer
[e first computer:—
[i receives sequential authentication Code Q from second computer
[ii performs the same arithmetical function on the second computer's fixed value C and the sequential authentication Code P to check the validity of the second computer's sequential authentication Code Q
[iii if authenticated, using an arithmetical function on the first computer's fixed value A and the sequential authentication Code Q just received and resulting in sequential authentication Code R
[iv sends the sequential authentication Code R to first computer and so on at predetermined non-critical intervals of time with both computers having means for recording and recalling as required the different fixed values A and C and the received sequential authentication Codes

17 A method and apparatus for the authentication of a portable data carrying card capable of interacting with a computer and having facilities for reading and recording data and for inputting data from memory into that computer by means of a card reader attached to the computer as in claim [16 wherein the first computer is taken to be a central master computer and the second is taken to include any subsidiary related computer into which may be inserted such a portable data carrying card with memory function including memory of fixed value equivalent to C, the most recent sequential authentication Code received and instructions for carrying out the calculation, and whereby the calculation functions are passed to and carried out by the second computer with the resultant sequential authentication Code submitted to the first computer for authentication followed by the recording of that sequential authentication Code as the next random function on both the first computer and on the data carrying card, and so on repeated as frequently as may be required.

18 A method and apparatus for the digital authentication of documents prepared by a person registered in a system to the Controller of that system comprising the following steps
[a the registration of a person with the Controller of a system
[b the allotment of an account number to the person
[c the agreement between the person and the Controller of fixed data elements and of the arithmetical and other processes to be applied to input data
[d the registration with the Controller of a Fixed Personal Identification (“FPI”) selected by the person
[e the transmission by the Controller to the person of a starting value, consisting of a series of random digits, in a secure manner as practised in the art
[f the transmission by the Controller of software for computing the authentication Codes and in particular for remembering the sequential value of the preceding authentication Code
[g on the first occasion of use, the input by the person of the fixed data, the starting value and the FPI into a personal computer where the input data is subject to arithmetical or other processes from which is derived the first variable authentication Code
[h on the second and subsequent occasions of use, the input by the person of the FPI and the automated input by the personal computer of the fixed data and of the immediately preceding authentication Code as a random variable and wherein the input data is subject to arithmetical or other processes from which is derived the next variable authentication Code
[i means for remembering the authentication Code for both use as a variable authentication Code but also as a sequential value in the next authentication Code calculation and for enabling the recording of the authentication Code onto the relevant document
[i means for transporting the sequential values and other fixed values where the person wishes to be authenticated away from the personal computer wherein most of the fixed and variable data is held on a portable data carrying card capable of interacting with a computer and having facilities for reading and recording data and for inputting data from memory into that computer by means of a card reader attached to the computer on the input by the person of the remaining required data including a FPI of more than 1 character
[k means for an interested party to obtain authentication of a document with the Controller of the system by reference to the person's account number and authentication Code

19 A method and apparatus for digital authentication of as in claim [18 wherein the document is a check, the person is an account holder and a bank manager is both the Controller of the system and an interested party

20 A method and apparatus for authentication as in claim [9 wherein instead of the FPI input to the computation of the authentication Code as described, the term FPI is taken to mean a digital input made available by the person through submission by that person to a form of Biometric recording device which reads physical characteristics and inputs a digital value regarded as unique to the person.
